(19) United States
(12) Patent Application Publication
(10) Pub. No.: US 2010/0289566 A1
(43) Pub. Date: Nov. 18, 2010

(54) Amplitude AC noise filter with universal IEC connection

(76) Inventors: Jimmy Ko, San Ramon, CA (US); Mitch Ko, Livermore, CA (US)

Correspondence Address: SAILE ACKERMAN LLC, 28 DAVIS AVENUE, POUGHKEEPSIE, NY, 12603, US

(21) Appl. No.: 12/454,218

(22) Filed: May 14, 2009

(51) Int. Cl. H04B 1/00

(52) U.S. Cl. 327/552

(57) ABSTRACT

An AC noise filter designed to filter the small amplitude AC noise of all frequencies by using inline reverse coupled parallel PN semiconductors which offer a high resistance to AC voltages of less than a diode voltage drop. Inline reverse coupled parallel PN semiconductors are used in the AC power line-side as well as in the neutral-line side. For additional AC noise filtering, capacitors are coupled across the AC or DC power source input and at the output to the AC or DC user. For the AC power, IEC connectors are used at the input and output for worldwide use.

### BACKGROUND OF THE INVENTION

1. Field of the Invention

The invention relates to an apparatus to filter out AC noise, and more particularly to a small sized AC noise filter to filter small amplitude noise of all frequencies from the AC or DC power source.

2. Description of the Related Art

High-end audio devices and precise testing and measurement instruments are sensitive to line noise from alternating current (AC) power sources and from crosstalk from other appliances. To improve performance, some sensitive devices even request isolated direct current (DC) such as batteries as the power supply to avoid line noise.

FIG. 1a shows the routes by which noise enters device A. Devices A, B and C are plugged into the AC power source 11 (voltage and ground), e.g., an AC wall socket with individual AC power lines (voltage and ground). The power cables 12-1, 12-2 and 12-3 are used to connect the devices A, B and C to AC power source 11, respectively. The interconnect signal lines/cables 13-1 and 13-2 are used to connect devices A and B as well as B and C. The noise received by device A could come from the AC power source directly as indicated by dashed line 1, from crosstalk from devices B and C as indicated by dashed lines 2 and 3, respectively, or back reflection from device B, as indicated by dashed line 4. The noise cannot be eliminated by simply transforming the AC power to DC power. FIG. 1b shows the AC power is transformed to DC power by units DC 14 before entering the devices A, B, C. The AC-to-DC transformation could be made by the DC power supply, AC-DC switching power or batteries with the AC charger connecting to an AC power source. The AC noise still exists on the DC power line after AC-DC transformation. The best way to eliminate noise from the power lines (dashed line 1) and crosstalk from other devices (dashed lines 2 and 3) is to use DC batteries 15 which are completely isolated from the AC power source, i.e., without a charger connecting to the AC power lines, as shown in FIG. 1c. However, because of the short, limited usage time and the cost and lifetime of the battery, AC power is still the main stream for most electrical apparatuses.

An interconnect signal cable with very low back reflection is disclosed in U.S. Pat. No. 7,327,919, “Fiber Optic Audio Cable”, and assigned to the assignee, is incorporated herein in its entirety by reference.

To isolate noise from AC power lines an AC Power Filter, called a Filter/Isolator/Conditioner (F/I/C), 21 is added between the AC power line 11 and devices A, B and C, respectively, as shown in FIG. 2. The type of AC noise is shown in FIG. 3a as a waveform graph 30, where Curve 31 indicates the AC sine wave line voltage with a frequency of 50 Hz or 60 Hz, where Curve 32 indicates low frequency noise and Curve 33 indicates high frequency noise. For instance, the AC line frequency is 60 Hz in USA and 50 Hz in most European countries. FIG. 3a also shows that the high-frequency noise and the low-frequency noise have a small amplitude compared with the AC line voltage. In the real world, the various high and low frequencies of noise are carried on the same lines with the AC power. In case of the DC power source transformed from AC power lines, FIG. 3b shows that the small amplitude AC noise 32 and 33 still exists on the DC power lines unless the DC power source is completely isolated from the AC power lines, e.g., batteries without connection of AC power lines as shown in Curve 35 of FIG. 1c.

AC filters of the present art use frequency-discriminating filters such as low pass, high pass and band pass (a combination of a low and a high pass filter) filters as shown in FIGS. 4a, 4c, and 4e (a combination of FIGS. 4a and 4c), respectively. Inductors L1 and L2 are used to block the high frequency noise, and capacitors C1 and C2 are used to block the low frequency noise. AC indicates the AC power source. In FIGS. 4a and 4c, the junction of capacitor C2 and inductor L2 is shown tied to ground (GND). In graphs of frequency vs. gain, Curve 41 of FIG. 4b, Curve 42 of FIG. 4d, and Curve 43 of FIG. 4e show the response for the low pass, high pass, and band pass filters, respectively. In some cases, for better performance, multiple stages of low/high pass filters are even required. The main disadvantage of the frequency-based filters is not being able to filter out the noise with frequencies around the main signal i.e. the AC power source. Also, the low pass filter cannot be used to filter the noise in the DC power line as shown in FIG. 3b, Curves 32 and 33. In addition, to have good filtering results the combination of inductors and capacitors is typically bulky. Therefore, most AC Power F/I/Cs are built as a box type with multiple channels. To reduce the device dimensions, some electrical parts and ground must be shared by each channel in a multi-channel power conditioner. Then the components and ground sharing inside the multi-channel conditioner box causes new crosstalk problems.

Patents which relate to the present invention are:

U.S. Pat. No. 5,451,852 (Gusakov) describes a multi-window filter where an op amp is used to provide a high impedance load to a first order low pass filter. The window threshold signal level is determined by the forward junction voltage drops of two diodes. Where the reverse parallel combination of those two diodes will conduct for voltage drops greater than ±0.7 volts.

U.S. Pat. No. 7,190,769 (Chuk et al.) discloses a filtering section 194 configured to filter AC noise (e.g., a 60 Hz AC line signal) and avoid having AC noise interfere with operation of an indicating section. A combination of resistors and a bipolar transistor achieve that. However only noise in the 60 Hz range is filtered.

U.S. Pat. No. 4,634,895 (Luong) shows a CMOS cicuit where one aspect of the invention is to provide a low frequency AC filter utilizing a tandem arrangement of positive and negative peak detectors. Level shifters of that circuit also function to provide AC filtering of input signal V-AC such that frequencies above, for example, 100 KHz are removed. This circuit suffers from requiring a large number of transistors.

It should be noted that none of the above-cited examples of the related art provide the advantages of the below described invention. These needs are met by the invention, which cuts off the amplitude of the noise from the power source instead of frequency and uses semiconductors instead of bulky inductors/capacitors.

### SUMMARY OF THE INVENTION

It is an object of at least one embodiment of the present invention to provide a method and an apparatus which filters and isolates noise in the entire range of frequencies, including 50˜60 Hz, from the AC power line.

It is another object of the present invention to provide a method and apparatus which filters and isolated noise in the entire range of frequencies from DC power line.

It is yet another object of the present invention to provide an Amplitude AC noise filter that is built as a single-channel in-line device with or without a power cable.

It is still another object of the present invention to provide an Amplitude AC noise filter where the filter can be put very close to the instrument to minimize the EMI contamination/influence after filtering.

It is a further object of the present invention to provide an Amplitude AC noise filter that is added between an existing AC power cord and an instrument as an in-line device.

It is yet a further object of the present invention is to provide an Amplitude AC noise filter which can be used worldwide without an adapter for the local power socket.

It is still a further object of the present invention is to better isolate the crosstalk between each electrical component/device than current conventional frequency-based AC noise filters.

These and many other objects have been achieved by providing an Amplitude AC noise filter comprising a circuit with a sharp break point in the V vs. I graph, typical of a diode; and coupling such circuits in the supply and/or return line between an AC or DC power source and a electrical device using that AC or DC power. In addition, small capacitors or devices acting like capacitors may be coupled across the inputs and/or outputs of such an Amplitude AC noise filter to filter out other high frequency noise.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIGS. 1a, 1b and 1c are schematics showing the paths where noise enters devices attached to an AC power line.

FIG. 2 is a schematic showing AC Power F/I/Cs coupled between the devices and the AC power line of FIG. 1a.

FIG. 3a is a waveform graph of the AC sine wave line voltage and noise on the AC power line.

FIG. 3b is a waveform graph of DC line voltage and AC noise on the DC power line.

FIGS. 4a to 4e show frequency-discriminating filters and their respective frequency responses.

FIG. 5a shows a RC filter circuit.

FIG. 5b shows a PN semiconductor filter circuit of the preferred embodiment of the present invention.

FIG. 5c is a graph of the voltage vs. current response of the RC filter circuit of FIG. 5a and of preferred embodiments of PN semiconductor filter circuits of FIG. 5b of the present invention.

FIG. 6a shows a form-factor example of the amplitude noise filter for AC power of the present invention.

FIGS. 6b and 6c show an example of an International Electrotechnical Commission (IEC) line plug outlet and an IEC chassis socket inlet of the present invention.

FIG. 6d shows a form-factor example of the amplitude noise filter for DC power of the present invention.

FIG. 7 shows connection methods for the amplitude filter of the present invention.

FIG. 8 is a block diagram of the method of the present invention.

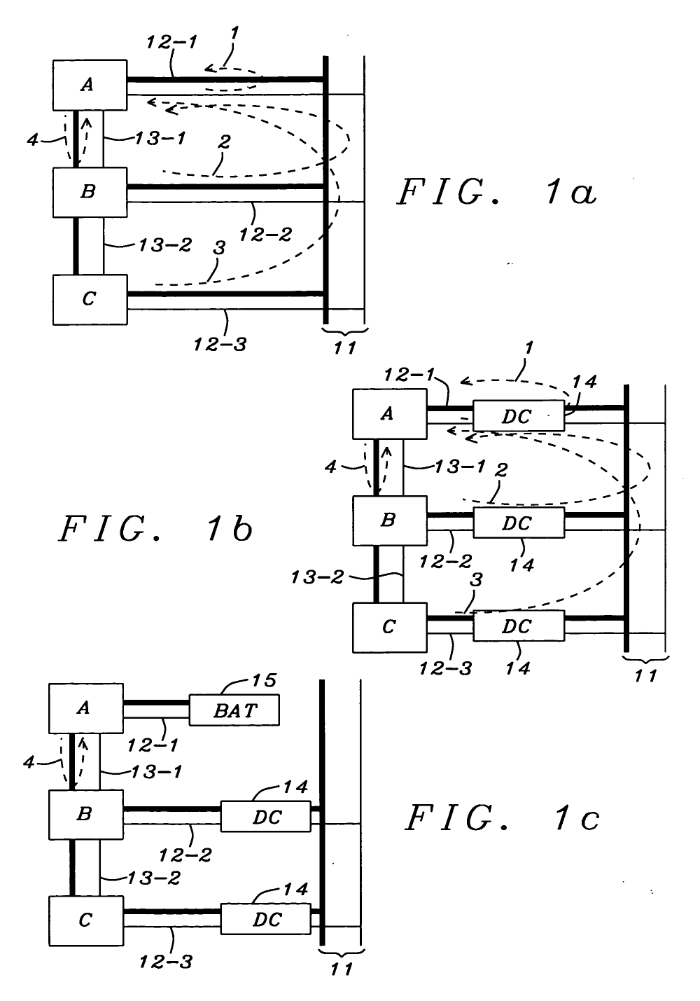

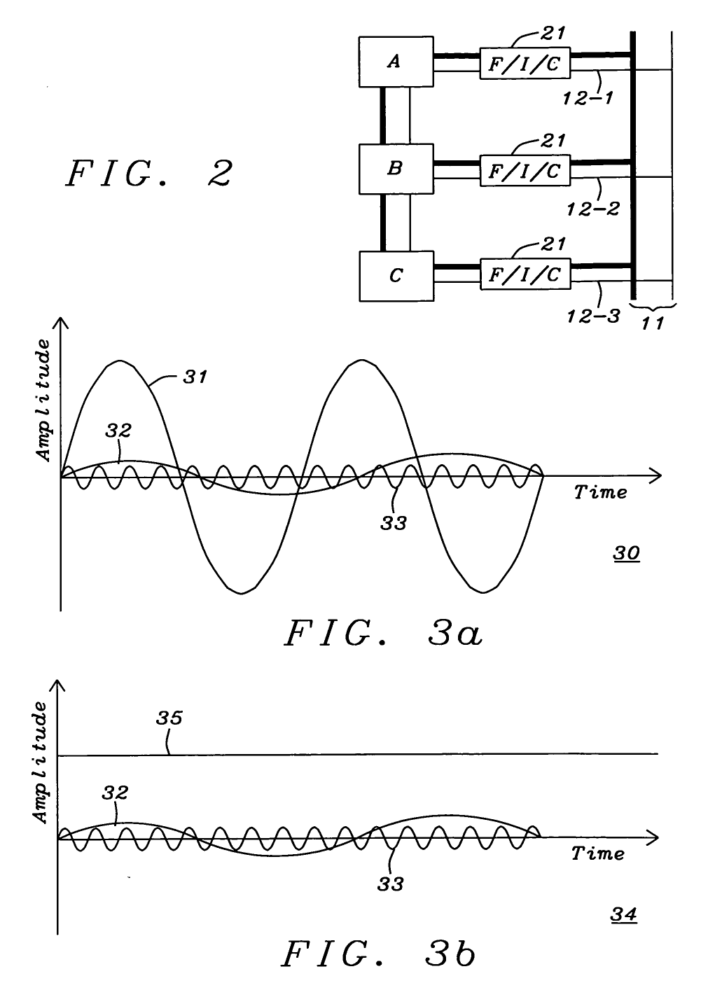

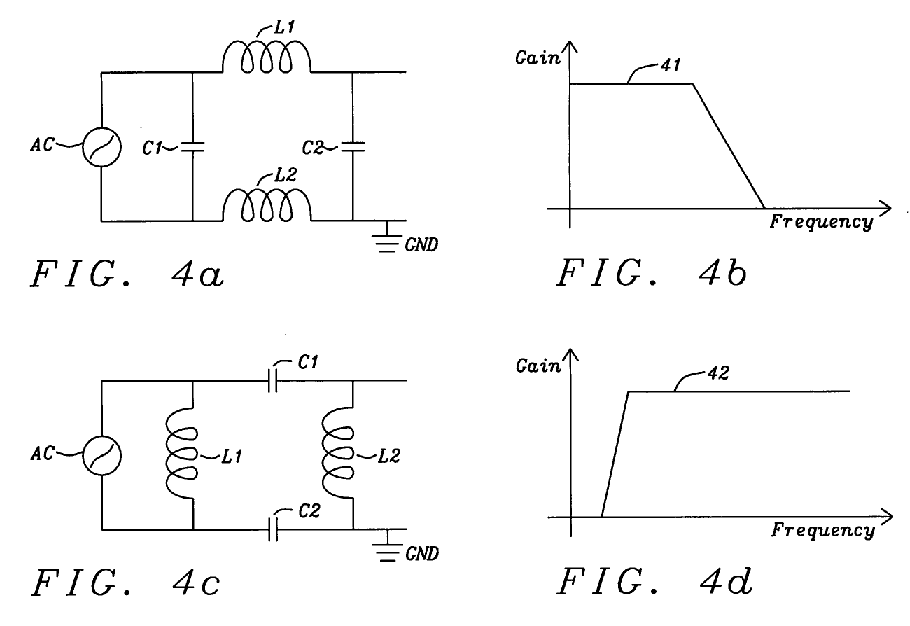

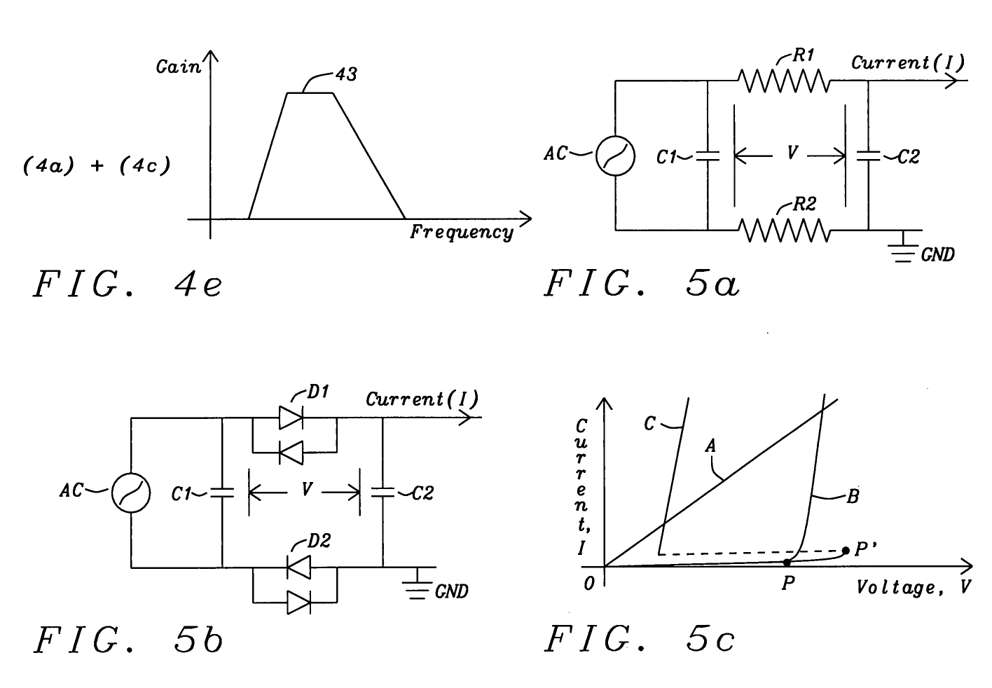

Use of the same reference number in different figures indicates similar or like elements.

### DESCRIPTION OF THE PREFERRED EMBODIMENT

Referring now to FIG. 5a, we show a RC filter circuit comprising resistors R1 and R2 and capacitors C1 and C2 coupled to an alternating current (AC) power source. The pass current of this circuit is proportional to the voltage (amplitude) as shown by Curve A of the graph of voltage (V) vs. current (I) of FIG. 5c. In FIG. 5a the junction of capacitor C2 and resistor R2 is shown tied to ground (GND). When in a preferred embodiment of the present invention, as illustrated in FIG. 5b, resistors R1 and R2 are replaced by PN semiconductor circuits D1 and D2 (shown by way of example, but not limited to that example, as a reverse coupled parallel diode circuit) the Voltage (V) vs. Current (I) response changes in a nonlinear fashion, as shown by Curve B of FIG. 5c, where Curve B represents the V-I characteristics of a PN semiconductor. Voltage (V) is the voltage across each resistor R1, R2 or each PN semiconductor circuit D1, D2, and current (I) is the current through the devices. Circuits D1 and D2 are shown by way of example, but not limited to that example, as a reverse coupled parallel diode circuit. Other circuits and devices providing a sharp break point P as illustrated by Curve B are also suitable. The junction of capacitor C2 and PN semiconductor D2 in FIG. 5b is tied to ground (GND). Anodes of D1 and D2 are marked +, cathodes are marked −. Capacitors C1 and C2 may be replaced by semiconductor devices such as, but not limited to, NMOS, PMOS, NPN, PNP, photo transistors, SCRs, and photo SCRs.

The V-I characteristics of the PN semiconductor circuits D1, D2 shows that PN semiconductors have a high resistance region (non-conducting) between the origin O and Point P of the graph of FIG. 5c and a low resistance region (conducting) beyond (to the right of) Point P. The AC noise filter circuit of FIG. 5b therefore blocks small amplitude AC signals because the circuit presents a high resistance when the amplitude of the AC signal is between the origin O and Point P of the graph of FIG. 5c. The AC noise filter thus blocks AC noise having an absolute amplitude equal to a PN semiconductor voltage drop. However to high amplitude AC signals, such as AC power line voltages, the circuit of FIG. 5c offers a very low resistance and therefore high amplitude AC signals are passed through because their amplitude far exceeds the voltage at Point P. The filtering is independent of frequency and therefore blocks equally well high and low frequency noise signals. The circuit is therefore very useful in filtering small amplitude noise carried on the AC power lines in the entire range of frequencies as depicted by Curves 32 and 33 of FIG. 3a. PN semiconductor circuits D1 and D2 are shown by way of example, but not limited to that example, as a reverse coupled parallel combination of two diodes. In a reverse coupled parallel diode circuit, comprising two diodes, the cathode of the first diode is coupled to the anode of the second diode and the cathode of the second diode is coupled to the anode of the first diode. At any one instance one diode blocks noise having a positive amplitude while the other diode blocks noise with a negative amplitude. Other semiconductor elements may also be used such as NMOS, PMOS, NPN, PNP transistors.

In a second preferred embodiment of the present invention, other types of inverse parallel coupled semiconductors such as Silicon controlled rectifiers (SCRs), photo coupler SCRs, photo coupler transistors or bidirectional triode thyristors (TRIACs) are utilized. SCRs and similar devices have a different V-I graph than standard PN semiconductors, as illustrated by Curve C. Curve C has a breakover Point P′ and is characteristic of an SCR. When the signal amplitude increases beyond Point P′ a significant reduction in the voltage drop across the SCR occurs and the current increases rapidly. Compared to the conventional PN semiconductor, the power consumption of SCRs is much less.

In a third preferred embodiment of the present invention and again referring to FIG. 5b, connecting a plurality and various D1 and D2 circuits in series will move the Point P to a higher voltage to filter out noise with a larger amplitude. The AC noise filter therefore blocks AC noise having an absolute amplitude equal to the voltage drop of a plurality of PN semiconductor devices coupled in series.

In a similar manner and referring to Curve C of FIG. 5c, connecting a plurality and various inverse parallel coupled semiconductors such as Silicon controlled rectifiers as discussed above in series will move the Point P′ to a higher voltage to filter out noise with a larger amplitude. The AC noise filter with the characteristics of Curve C therefore blocks AC noise having an absolute amplitude equal to the voltage drop of a plurality of semiconductor devices coupled in series.

Still referring to the AC noise filter circuit 5b, the PN semiconductor circuit D1 further comprises reverse coupled parallel diodes arranged as a first diode circuit coupled between line-side terminals of the input and output of the Amplitude AC noise filter, the first diode circuit comprising a first and a second diode, where the cathode of the first diode is coupled to the anode of the second diode and where the cathode of the second diode is coupled to the anode of the first diode. The PN semiconductor circuit D2 further comprises reverse coupled parallel diodes arranged as a second diode circuit coupled between neutral-side terminals of the input and output of the Amplitude AC noise filter, the second diode circuit comprising a third and a fourth diode, where the cathode of the third diode is coupled to the anode of the fourth diode and where the cathode of the fourth diode is coupled to the anode of the third diode. The set of diodes of FIG. 5b that are forward biased from the line-side terminal to the neutral-side terminal are blocking small positive amplitude AC voltages, the other set of diodes that are forward biased from the neutral-side terminal to the line-side terminal are blocking small negative amplitude AC voltages.

The Amplitude AC noise filter of the present invention made with PN semiconductors has a relatively small size compared the frequency-based filters made with coils and capacitors. It can easily be fitted into an enclosure with a diameter of about 0.5 inch×1.8 inch length. This small form factor filter is then suitable as a pluggable in-line device. Furthermore, since the filter is small in size it can be in very close proximity to the instrument it serves to minimize electromagnetic interference (EMI) contamination or EMI influence after filtering.

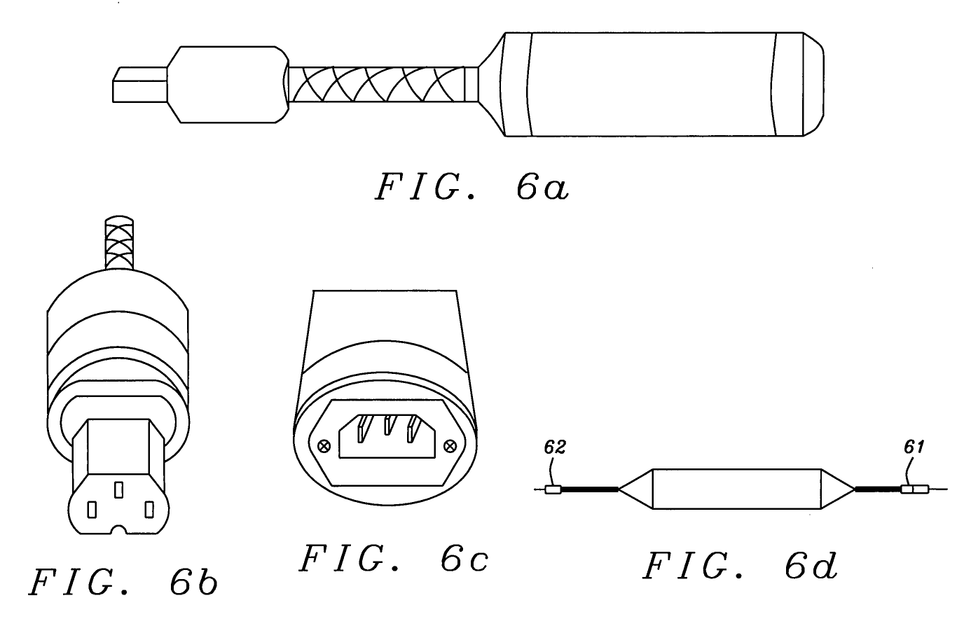

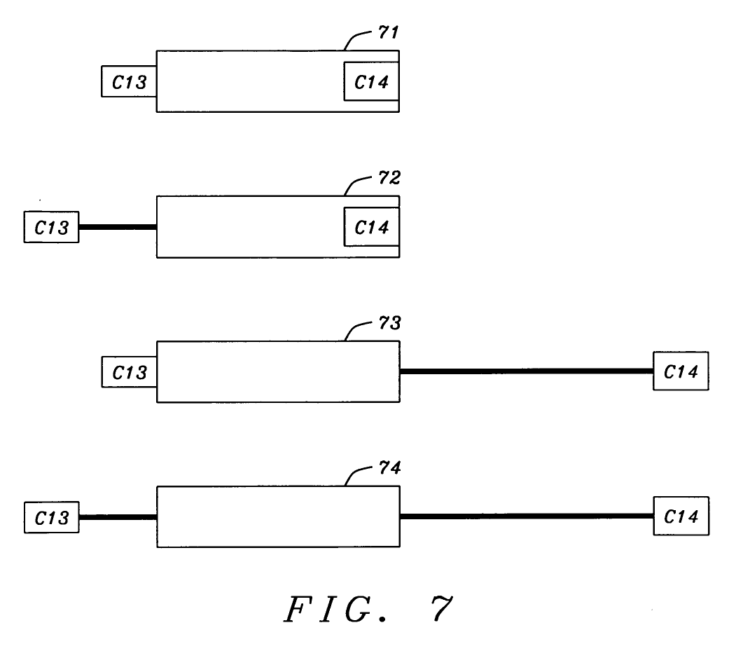

FIG. 6a is an example of the form factor for the Amplitude AC noise filter for AC power. FIG. 6b shows the International Electrotechnical Commission (IEC) connector for the outlet (C13/C15) and FIG. 6c shows the IEC connector for the inlet (C14/C16). The cylindrical shape and the dimensions of the Amplitude AC noise filter in FIGS. 6a, 6b and 6c are shown by way of example, but not limited to that example, and do not necessarily represent a final implementation. The AC power cables with IEC connector on the outlet can be used with the noise filter module, and the type of local power socket does not matter. FIG. 6d is an example of the form factor for the Amplitude AC noise filter for DC power. The inlet DC female socket 61 and outlet DC male plug 62 are shown by way of example, but not limited to that example.

FIG. 7 illustrates more connection methods for the filter module:
Connection module 71 shows an Amplitude AC noise filter with a chassis socket inlet C14 and with a built in line plug outlet C13;
Connection module 72 shows an Amplitude AC noise filter with a chassis socket inlet C14 and with an attached line plug outlet C13;
Connection module 73 shows an Amplitude AC noise filter with an attached socket inlet C14 and with a built in plug outlet C13; and
Connection module 74 shows an Amplitude AC noise filter with an attached socket inlet C14 and with an attached plug outlet C13. Approximate dimensions for the Amplitude AC noise filter are of a cylinder with a diameter of 1.8 inches and a length of 5.0 inches or of a rectangular shape of 1.2×0.8 and a length of 2.5 inches and are given by way of example, but not limited to those examples, and do not represent the final dimensions nor form factor.
   For the DC power, the Amplitude AC noise filter module could be down to a diameter of 0.5 inches and a length of 1.8 inches due to thinner wires/cables and a lower power consumption than the AC power.

Furthermore, the filter module can be incorporated into audio components and other instruments as a built-in Amplitude AC noise filter.

### Advantages

Advantages of the present invention are:
1. Filtering and isolation of AC noise in the entire range of frequencies, including 50˜60 Hz, from the AC power line.
2. Filtering and isolation of AC noise in the entire range of frequencies from the DC power line.
3. The small form-factor filter can be built as a single-channel in-line device with or without the AC power cable, and the filter can be put very close to the end user to minimize EMI contamination/influence after filtering.
4. The device can be added between an existing AC or DC power cord and an instrument as an in-line device. The existing power cord does not need to be replaced.
5. For AC power, by using IEC connectors for the inlet and outlet connections, the device can be used worldwide without an adapter for the local power socket.

Since the reduction of the AC noise is too small to be tested by an oscilloscope, the following test procedure is recommended to measure the noise reduction from an AC power line:
1. Plug AC power lines to audio amplifiers which have no audio source/input connection.
2. Measure the noise sound from speakers. Adjust the gain of amplifiers if necessary.
3. Insert the AC noise filter into the AC power line. Then, measure the noise sound from speakers as step 2.
4. The noise reduction is the difference between measurements in step 2 and 3.

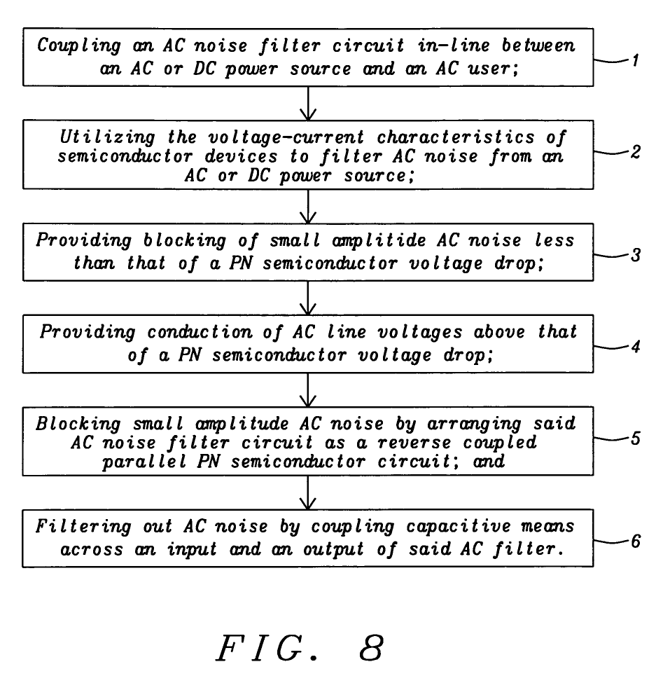

We now describe the method of the preferred embodiment of the present invention with reference to the block diagram of FIG. 8:
Block 1 couples an AC noise filter circuit in-line between an AC or DC power source and a power user;
Block 2 utilizes the voltage-current characteristics of PN semiconductor devices to filter AC noise from an AC or DC power source;
Block 3 provides blocking of small amplitude AC noise less than that of a PN semiconductor voltage drop;
Block 4 provides conduction of AC line voltages above that of a PN semiconductor voltage drop;
Block 5 blocks small amplitude AC noise by arranging the AC noise filter circuit as a reverse coupled parallel PN semiconductor circuit; and
Block 6 filters out AC noise by coupling capacitive means across the AC noise filter input and output.

While the invention has been particularly shown and described with reference to the preferred embodiments thereof, it will be understood by those skilled in the art that various changes in form and details may be made without departing from the spirit and scope of the invention.

What is claimed is:

1. An amplitude AC noise filter, comprising:
an AC noise filter circuit coupled between an input and an output, said AC noise filter circuit comprising semiconductor devices to filter AC noise from an AC or DC power source by utilizing the voltage-current characteristics of said semiconductor devices, where said semiconductor devices block a small amplitude, equal to a PN semiconductor voltage drop, AC voltage when in a high resistance region and passes an AC or DC line voltage, above a PN semiconductor voltage drop, when in a low resistance region.

2. The amplitude AC noise filter of claim 1, wherein said AC noise filter circuit further comprises:
a first semiconductor circuit coupled between a first terminal of said input and a first terminal of said output; and
a second semiconductor circuit coupled between a second terminal of said input and a second terminal of said output.

3. The amplitude AC noise filter of claim 2, wherein said first and said second semiconductor circuit each further comprises:
a first and a second diode where the cathode of said first diode is coupled to the anode of said second diode and where the cathode of said second diode is coupled to the anode of said first diode.

4. The amplitude AC noise filter of claim 1, wherein said AC noise filter circuit further comprises:
first capacitive means coupled between a first and a second terminal of said input, said first capacitive means short-circuiting said AC noise; and
second capacitive means coupled between a first and a second terminal of said output, said second capacitive means short-circuiting said AC noise.

5. The amplitude AC noise filter of claim 4, wherein said first and second capacitive means are selected from the group consisting of capacitors, NMOS, PMOS, NPN, PNP, photo transistors, SCRs, photo SCRs.

6. The amplitude AC noise filter of claim 1, wherein said alternating current filter further comprises:
third capacitive-inductive means coupled between a first terminal of said input and a first terminal of said output, said third capacitive-inductive means blocking said AC noise; and
fourth capacitive-inductive means coupled between a second terminal of said input and a second terminal of said output, said fourth capacitive-inductive means blocking said AC noise.

7. The Amplitude AC noise filter of claim 6, wherein said third and fourth capacitive-inductive means are selected from the group consisting of capacitors, NMOS, PMOS, NPN, PNP, photo transistors, SCRs, photo SCRs.

8. The amplitude AC noise filter of claim 1, wherein said AC noise filter comprises inverse parallel coupled semiconductors selected from the group consisting of NMOS, PMOS, NPN, PNP transistors, Silicon controlled rectifiers (SCRs), photo coupler SCRs, photo coupler transistors, bidirectional triode thyristors (TRIACs).

9. The amplitude AC noise filter of claim 1, wherein said AC noise filter blocks AC noise having an absolute amplitude equal to the voltage drop of a plurality of semiconductor devices coupled in series.

10. The Amplitude AC noise filter of claim 1, wherein said AC noise filter blocks AC noise with frequencies in the range from 1 Hz to 1,000,000 (1M) Hz.

11. An amplitude AC noise filter, comprising:
an AC noise filter circuit coupled between an input and an output, said AC noise filter circuit comprising semiconductor devices to filter AC noise from an AC or DC power source by utilizing the voltage-current characteristics of said semiconductor devices, where said semiconductor devices block a small amplitude, equal to a PN semiconductor voltage drop, AC voltage when in a high resistance region and passes an AC or DC line voltage, above a PN semiconductor voltage drop, when in a low resistance region;
where said AC noise filter circuit further comprises:
reverse coupled parallel diodes arranged as a first diode circuit coupled between line-side terminals of said input and output, said first diode circuit comprising a first and a second diode where the cathode of said first diode is coupled to the anode of said second diode and where the cathode of said second diode is coupled to the anode of said first diode; and
reverse coupled parallel diodes arranged as a second diode circuit coupled between neutral-side terminals of said input and output, said second diode circuit comprising a third and a fourth diode where the cathode of said third diode is coupled to the anode of said fourth diode and where the cathode of said fourth diode is coupled to the anode of said third diode.

12. The amplitude AC noise filter of claim 11, wherein diodes of said first and second diode circuit that are forward biased from said line-side terminal to said neutral-side terminal are blocking small positive amplitude AC voltages.

13. The amplitude AC noise filter of claim 11, wherein diodes of said first and second diode circuit that are forward biased from said neutral-side terminal to said line-side terminal are blocking small negative amplitude AC voltages.

14. The amplitude AC noise filter of claim 11, wherein said AC noise filter further comprises:
first capacitive means coupled between a first and a second terminal of said input, said first capacitive means short-circuiting said unwanted AC noise; and
second capacitive means coupled between a first and a second terminal of said output, said second capacitive means short-circuiting said unwanted AC noise.

15. The amplitude AC noise filter of claim 14, wherein said first and second capacitive means are selected from the group consisting of capacitors, NMOS, PMOS, NPN, PNP, photo transistors, SCRs, photo SCRs.

16. The amplitude AC noise filter of claim 11, wherein said AC noise filter comprises inverse parallel coupled semiconductors selected from the group consisting of NMOS, PMOS, NPN, PNP transistors, Silicon controlled rectifiers (SCRs), photo coupler SCRs, photo coupler transistors, bidirectional triode thyristors (TRIACs).

17. The amplitude AC noise filter of claim 11, wherein said AC noise filter blocks AC noise having an absolute amplitude equal to the voltage drop of a plurality of semiconductor devices coupled in series.

18. The amplitude AC noise filter of claim 11, wherein said AC noise filter circuit blocks AC noise with frequencies in the range from 1 Hz to 1,000,000 (1M) Hz.

19. The amplitude AC noise filter of claim 11, wherein said input and output use IEC connectors.

20. A method of filtering AC noise from an AC or DC power source, comprising the steps of:
a) coupling an AC noise filter circuit in-line between an AC or DC power source and an AC or DC power user;
b) utilizing the voltage-current characteristics of semiconductor devices to filter AC noise from an AC or DC power source;
c) providing blocking of small amplitude AC noise less than that of a PN semiconductor voltage drop;
d) providing conduction of AC line voltages above that of a PN semiconductor voltage drop;
e) blocking small amplitude AC noise by arranging said AC noise filter circuit as a reverse coupled parallel PN semiconductor circuit; and
f) filtering out AC noise by coupling capacitances means across an input and an output of said AC noise filter.

21. The method of claim 20, wherein said reverse coupled parallel diode circuit further comprises:
a first and a second diode, where the cathode of said first diode is coupled to the anode of said second diode and the cathode of said second diode is coupled to the anode of said first diode, all coupled between the line-side of said of said AC power source and said AC user; and
a third and a fourth diode, where the cathode of said third diode is coupled to the anode of said fourth diode and the cathode of said fourth diode is coupled to the anode of said third diode, all coupled between the neutral-side of said of said AC power source and said AC user.

22. The method of claim 20, wherein said AC noise filter comprises inverse parallel coupled semiconductors selected from the group consisting of NMOS, PMOS, NPN, PNP transistors, Silicon controlled rectifiers (SCRs), photo coupler SCRs, photo coupler transistors, bidirectional triode thyristors (TRIACs).

23. The method of claim 20, wherein said AC noise filter blocks AC noise having an absolute amplitude equal to the voltage drop of a plurality of semiconductor devices coupled in series.

24. The method of claim 20, wherein said AC noise filter circuit blocks AC noise with frequencies in the range from 1 Hz to 1,000,000 (1M) Hz.

25. The method of claim 20, wherein said AC noise filter circuit provides IEC connectors for said input and said output for worldwide use.
